(19) United States
(12) Patent Application Publication
(10) Pub. No.: US 2025/0093169 A1
(43) Pub. Date: Mar. 20, 2025

(54) METHODS FOR ESTIMATING A TRAVEL ROUTE

(71) Applicant: Woven by Toyota, Inc., Tokyo (JP)

(72) Inventor: Jan Falkowski, Tokyo (JP)

(73) Assignee: Woven by Toyota, Inc., Tokyo (JP)

(21) Appl. No.: 18/468,095

(22) Filed: Sep. 15, 2023

(51) Int. Cl. G01C 21/34; G01C 21/36

(52) U.S. Cl. CPC G01C 21/3484; G01C 21/36

(57) ABSTRACT

The present disclosure is directed to methods for estimating a route of an object. The method includes determining a first position of an object at a first time, determining a second position of the object at a second time subsequent to the first time, automatically simulating a plurality of possible routes between the first position and the second position, ranking the plurality of possible routes between the first position and the second position, and estimating a most probable route from among the plurality of possible routes between the first position and the second position.

### FIELD

The present disclosure relates to methods for estimating a travel route.

### TECHNICAL BACKGROUND

Travel routes may be tracked using position data in order to create a record of where an object traveled and/or track where an object is currently traveling. The travel record or current travel path may be mapped such as on a pre-made roadway map. Locating methods, such as Global Position System (GPS) may sometimes have errors, have inadequate precision, and/or have lost or distorted signals, such as when objects are in busy areas, so the travel route must be estimated when the detected position is lost or is incorrect. Conventional route estimation methods can involve quickly estimating which route an object is following or may have taken, even if this route is not necessarily based on object data or enhanced route simulations.

### SUMMARY

Object position detection systems may have errors or may be interfered with, such as by tall buildings in an urban environment. Object position detection systems may be used to determine a route which has been traveled by an object and/or determine a current route being traveled by an object. Thus, methods must be used to estimate object routes when position data is temporarily unknown or is distorted. Object routes may be estimated by comparing the latest known position of the object to the closest possible route. This may overlook the movement characteristics of the object, such as object velocity, acceleration, and/or travel history. Further, this may too quickly determine an object route before the object route can be more accurately estimated. Therefore, there exists a need for a travel route estimation method which can utilize more object data and more accurately estimate the travel route.

The present method can more accurately estimate travel routes than conventional travel route estimation methods by utilizing object dynamic data and enhanced route simulations compared to conventional travel route estimation methods.

The system generally includes a position determining device, a processor, and a map of the area and/or road networks. The position determining device, the processor, and the map may be connected to one another, such as through a wired connection or a wireless network. The position determining device may be associated with an object. In some embodiments, the position determining device may be associated with a vehicle. The processor may compare data generated from the position determining device to the map. When an error is detected between the data generated and the map, or when there is distorted, incomplete, or missing data, the processor may estimate the actual current position or route taken by the object.

According to one embodiment, a method includes determining a first position of an object at a first time, determining a second position of the object at a second time subsequent to the first time, automatically simulating a plurality of possible routes between the first position and the second position, ranking the plurality of possible routes between the first position and the second position, and estimating a most probable route from among the plurality of possible routes between the first position and the second position.

According to another embodiment, a method includes tracking a route of an object along a mapped path to determine a tracked route of the object, determining a difference between the mapped path and tracked route of the object, simulating a plurality of possible corrected routes from the tracked route to the mapped path, ranking the plurality of possible corrected routes between the tracked route and the mapped path, and estimating a most probable corrected route from among the plurality of possible corrected routes between the tracked route and the mapped path.

Additional features and advantages of the technology described in this disclosure will be set forth in the detailed description which follows, and in part will be readily apparent to those skilled in the art from the description or recognized by practicing the technology as described in this disclosure, including the detailed description which follows, the claims, as well as the appended drawings.

### BRIEF DESCRIPTION OF THE DRAWINGS

The following detailed description of the present disclosure may be better understood when read in conjunction with the following drawings in which:

FIG. 1 schematically depicts a view of a network of devices for performing a method, according to one or more embodiments shown and described herein;

FIG. 2 schematically depicts a view of multiple possible estimated routes between a first position and a second position, according to one or more embodiments shown and described herein;

FIG. 3 schematically depicts a view of multiple possible estimated routes between a first position and a second position along a mapped path, according to one or more embodiments shown and described herein;

FIG. 4 schematically depicts a view of multiple possible estimated routes along a mapped path, according to one or more embodiments shown and described herein;

FIG. 5 schematically depicts a flowchart of a method according to one or more embodiments shown and described herein; and

FIG. 6 schematically depicts a flowchart of a method according to one or more embodiments shown and described herein.

Reference will now be made in greater detail to various embodiments of the present disclosure, some embodiments of which are illustrated in the accompanying drawings. Whenever possible, the same reference numerals will be used throughout the drawings to refer to the same or similar parts.

### DETAILED DESCRIPTION

Embodiments of the present disclosure are directed to methods for estimating a route of an object. The method may include determining at least one position of an object, such as with a position determining device. The at least one determined positions of the object may be compared by a processor to a map of the area. When there is missing position data or the position data has an error, the processor may estimate possible routes or positions of the object. In embodiments, the method may include simulating possible routes between the determined positions, ranking the possible routes, and estimating which route was the most probable route taken. In other embodiments, the method may include determining a route being taken by the object, determining a difference between the determined route and the map, and estimating the most probable actual route taken by the object.

Conventional route estimation methods may estimate routes that are not feasible. For example, conventional systems may estimate routes that are not on paths or roads, or involve improbable or impossible maneuvering of the object, such as estimating a route with a sharp turn when the object is traveling at a high rate of speed. Further, conventional route estimation methods may not simulate routes for a long enough duration, and may too quickly estimate that a route has been taken. Embodiments can improve route estimating by using vehicle data, such as travel history and dynamic data, as well as enhanced route simulation. The present system can result in more accurate and realistic route estimations, both in real time and after a journey has been completed.

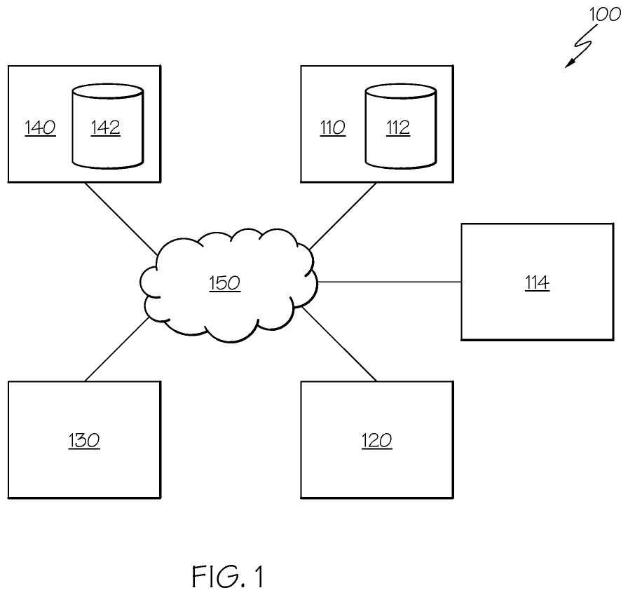

Referring now to FIG. 1, an example of a system 100 for estimating a route is shown consistent with a disclosed embodiment. As shown in FIG. 1, a processor 110, a position determining device 120, a dynamic sensor 130, a map device 140, and a display 114 are communicatively coupled to one another via a network 150. Although a specific numbers of processors, position determining devices, dynamic sensors, displays, and map devices are depicted in FIG. 1, any number of these devices may be provided. Furthermore, the functions provided by one or more devices of system 100 may be combined and the functionality of any one or more components of system 100 may be implemented by any appropriate computing environment.

Network 150 facilitates communications between the various devices in system 100, such as processor 110, position determining device 120, dynamic sensor 130, map device 140, and display 114. Network 150 may be a shared, public, or private network, may encompass a wide area or local area, and may be implemented through any suitable combination of wired and/or wireless communication networks. Furthermore, network 150 may include a local area network (LAN), a wide area network (WAN), an intranet, or the Internet. The network 150 may allow for near-real time communication between devices connected over the network.

Processor 110 may include a non-transitory, processor-readable storage medium 112 for storing program modules that, when executed by the processor 110, perform one or more processes described herein. Non-transitory, processor-readable storage medium 112 may store data from other devices, such as the position determining device 120 and the dynamic sensor 130. Non-transitory, processor-readable storage medium 112 may be one or more memory devices that store data as well as software and may also comprise, for example, one or more of RAM, ROM, magnetic storage, or optical storage. Since disclosed embodiments may be implemented using an HTTPS (hypertext transfer protocol secure) environment, data transfer over a network, such as the Internet, may be done in a secure fashion.

Position determining device 120 may be a device associated with an object 102 (described and illustrated herein) for determining the position of the object 102. The position determining device 120 may be a global positioning system (GPS) sensor, a global navigation satellite system (GNSS), or any other suitable device for determining the position of an object. The position determining device 120 may determine the position of the object 102 at a single point, a plurality of points so as to determine a route the object 102 is taking, or any other position of the object 102.

The dynamic sensor 130 may be a device associated with the object 102 for determining the dynamic characteristics of the object 102. The dynamic characteristics may be for example the direction of travel of the object 102, the speed of the object 102, the accelerations of the object 102, the yaw of the object 102, or other dynamic characteristics of the object 102. The dynamic sensor 130 may be a velocity sensor, an accelerometer, a yaw sensor, or any other suitable type of sensor. In some embodiments, the dynamic sensor may have the combined functionality of a velocity sensor, an accelerometer, and a yaw sensor such that the data may be captured simultaneously. In embodiments, the position determining device 120 and the dynamic sensor 130 may be combined into a single device for determining the position and dynamic characteristics of the object 102.

Map device 140 may be a computing device with a non-transitory, processor-readable storage medium. The non-transitory, processor-readable storage medium may contain map data 142. The map data 142 may be maps of roadways, paths, trails, or other areas with multiple possible routes. The map data 142 may be downloaded from a commercial map database, created by the object 102, or derived from any other suitable source.

Display 114 may be a screen or interface used to display information about the object 102, such as the detected position, route, or dynamic data. As a non-limiting example, when the object 102 is a vehicle, the display may be an infotainment screen. In another embodiment, the display 114 may be a mobile device such as a smart phone.

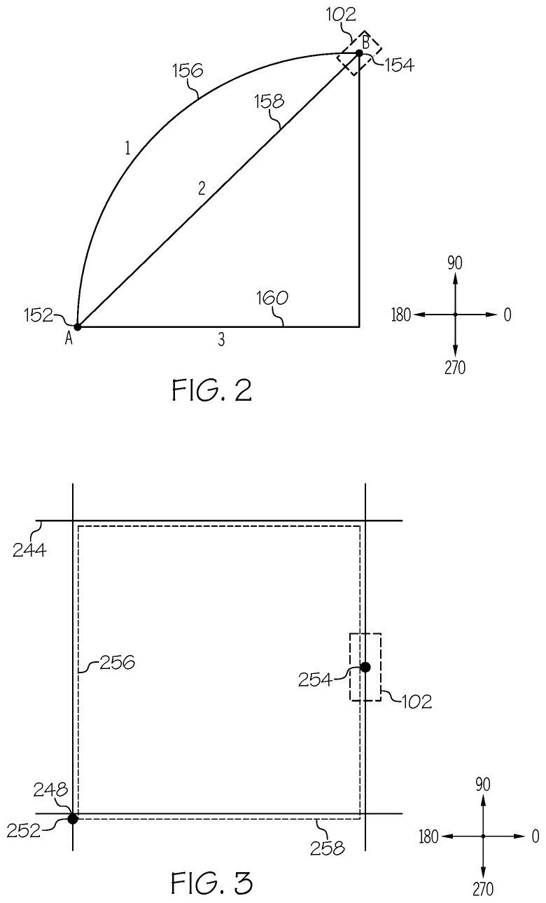

Referring now to FIG. 2, an illustration of the operation of the system 100 with object 102 is shown consistent with a disclosed embodiment. The object 102 may be a car, a bicycle, a human, an autonomous vehicle, or any other suitable object which may have their position tracked. The system 100 may determine a first position 152 of the object 102 at a first point in time, designated at point A. The system 100 may determine a second position 154 of the object 102 at a subsequent second point in time, designated at point B.

The positon of the object 102 between the first position 152 of the object 102 and the second position 154 of the object 102 may not be definitively known. For example, signal from the position determining device 120 may be lost or the data from the position determining device 120 may be distorted, such as in urban environments or areas with high interference.

The system 100 estimates the route traveled by the object between the first position 152 and the second position 154 of the object 102. The first position 152 and the second position 154 of the object 102 may be any two detected positions of the object 102, such as detected positions in a field. The system 100 determines one or more possible routes between the first position 152 of the object 102 and the second position 154 of the object 102. As illustrated, the system 100 may determine a first possible route 156 (labeled as route 1), a second possible route 158 (labeled as route 2), and a third possible route 160 (labeled as route 3). However, it should be understood that the system 100 may determine any number of possible routes, such as one possible route, two possible routes, four possible routes, five possible routes, ten possible routes, fifty possible routes, one hundred possible routes, one thousand possible routes, or any other suitable number of routes.

The system 100 ranks the possible routes between the first position 152 and the second position 154 of the object 102. The system 100 may rank the possible routes by any suitable criteria, including but not limited to the distance of the possible routes, the dynamics of the object 102 at the first position 152 of the object 102 and/or the second position 154 of the object 102, an object travel history between the first position 152 of the object 102 and the second position 154 of the object 102, or any other suitable criteria. As a non-limiting example, the system 100 may rank a possible route with a shorter distance as more likely than a possible route with a longer distance.

The system 100 may determine the dynamics of the object 102 at the first position 152 and the second position 154 of the object 102. As a non-limiting example, the system 100 may determine the velocity of the object 102 at both the first position 152 and the second position 154 of the object 102 with the dynamic sensor 130. The system 100 may compare the respective velocities to the multiple possible routes in order to rank the routes.

As a non-limiting example, if the velocity of the object 102 is determined to be at a 45 degree angle relative to the axis illustrated at the first position 152 and the second position 154, the system 100 may rank the second possible route 158 as most likely because the second possible route 158 follows the determined velocity at both the first position 152 and the second position 154 of the object 102. In another embodiment, the system 100 may determine the yaw of the object 102 at the first position 152 of the object 102. If the detected yaw at the first position 152 of the object 102 indicates the object 102 making a right-hand turn at first position 152, the system 100 may rank the third possible route 160 as most likely.

In embodiments, the system 100 may store known routes previously taken by the object 102 between the first position 152 of the object 102 and the second position 154 of the object 102. The known routes may also be referred to as the travel history of the object 102. The system 100 may rank a possible route that more closely matches the travel history of the object 102 as more likely than possible routes that differ from the travel history of the object 102.

In embodiments, the system 100 may use a combination of criteria to rank the plurality of possible routes, such as using a combination of object dynamic data, travel history, route distance, and/or any other suitable criteria.

Referring now to FIG. 3, an illustration of the operation of the system 100 is shown consistent with a disclosed embodiment. The first position 252 of the object 102 may be at an intersection 248 of two roads of a mapped road network 244, such that the roads which make up the mapped road network 244 are illustrated as solid lines. The second position 254 of the object 102 may be another position along the mapped road network 244. The system 100 may determine one or more possible routes between the first position 252 of the object 102 and the second position 254 of the object 102 along the mapped road network 244. The system 100 may recognize that the object 102 is traveling about the mapped road network 244, and determine the one or more possible routes along the mapped road network 244. In other words, the system 100 may not generate routes which would travel off of the mapped road network 244. The plurality of possible routes are illustrated as dashed lines. As illustrated, the system 100 may generate a first possible route 256 and a second possible route 258. The system 100 may rank the plurality of possible routes between the first position 252 and the second position 254 of the object 102.

In embodiments, the system 100 may rank the plurality of possible routes using similar criteria discussed above. For example, the system 100 may rank the plurality of possible routes based on object dynamic data, object travel history, route distance, and/or other suitable criteria. In embodiments, the system 100 may rank the plurality of possible routes based on a combination of more than one criteria.

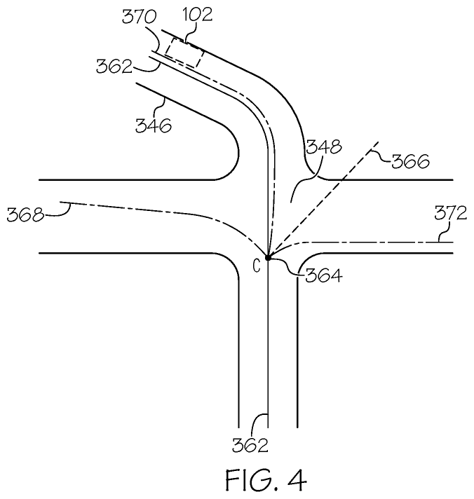

Referring now to FIG. 4, an illustration of the operation of the system 100 is shown consistent with a disclosed embodiment. The object 102 is shown as travelling along a mapped path 346. As a non-limiting example, the mapped path 346 may be a series of roads, a series of walking paths, or any other suitable series of paths. The system 100 tracks a route of the object 102. An actual route 362 of the object 102 shows the actual route taken by the object 102. The position determining device 120 may temporarily lose signal or receive distorted signal, such as in a densely populated urban area. A point of signal loss or distortion 364 is illustrated as point C. A detected route 366 is shown with dashed lines. The system 100 may recognize that the detected route 366 is outside of the mapped path 346, and therefore that the actual route 362 taken by the object 102 differs from the detected route 366. Therefore, the system 100 will need to estimate the corrected route taken by the object 102.

The system 100 may simulate a plurality of possible corrected routes originating from the point of signal loss or distortion 364. As illustrated, the system 100 may simulate a first simulated route 368, a second simulated route 370, and a third simulated route 372. The plurality of simulated routes may project in various directions originating from the point of signal loss or distortion 364. Compared to conventional route estimation systems, the system 100 may simulate the plurality of possible routes such that the routes extend further from the point of signal loss or distortion 364. This may provide a more detailed simulated route in order to more accurately estimate the actual taken by the object 102.

The system 100 may rank the plurality of possible corrected routes. That is, the system 100 may decide which of the plurality of simulated routes is the most likely route taken by the object 102. In one embodiment, the system 100 may rank the plurality of possible corrected routes based on a travel history of the object. That is, the system 100 may store a record of previous routes taken by the object 102 along the same section of the mapped path 346. The system 100 may rank a simulated route more similar to the record of the previous routes taken by the object 102 as more likely than a simulated route which is not similar to the record of the previous routes taken by the object 102. As a non-limiting example, if the object 102 frequently makes a left turn through the intersection 348, the system 100 may rank the first simulated route 368 as more likely than the second simulated route 370 or the third simulated route 372.

In another embodiment, the system 100 may rank the plurality of possible corrected routes based on the velocity of the object 102 at the point of signal loss or distortion 364. That is, the dynamic sensor 130 may determine the velocity of the object 102 at the point of signal loss or distortion 364 and the system 100 may use the velocity of the object 102 to rank the plurality of simulated routes. As a non-limiting example, if the velocity of the object 102 at the point of signal loss or distortion 364 is too high for the object 102 to make a turn, the system 100 may rank the second simulated route 370 (with the object 102 traveling straight through the intersection 348) as more likely than the first simulated route 368 and the third simulated route 372 (with the object 102 making a turn through the intersection 348).

In yet another embodiment, the system 100 may rank the plurality of possible corrected routes based on the acceleration of the object 102 at the point of signal loss or distortion 364. That is, the dynamic sensor 130 may determine the acceleration of the object 102 at the point of signal loss or distortion 364 and the system 100 may use the acceleration of the object 102 to rank the plurality of simulated routes. As a non-limiting example, if the object 102 is detected by the dynamic sensor 130 to be decelerating at the point of signal loss or distortion 364 and the map data 142 indicates that there is not a stop sign or traffic signal at the intersection 348, the system 100 may rank the first simulated route 368 and the third simulated route 372 (with the object 102 making a turn through the intersection 348) as more likely than the second simulated route 370 (with the object 102 traveling straight through the intersection 348).

With reference to FIGS. 2-4, the system 100 may display the tracked route and/or position of the object 102 onto the display 114. In embodiments, the system 100 may display the plurality of simulated routes onto the display 114. In other embodiments, the system 100 may display the estimated route onto the display 114.

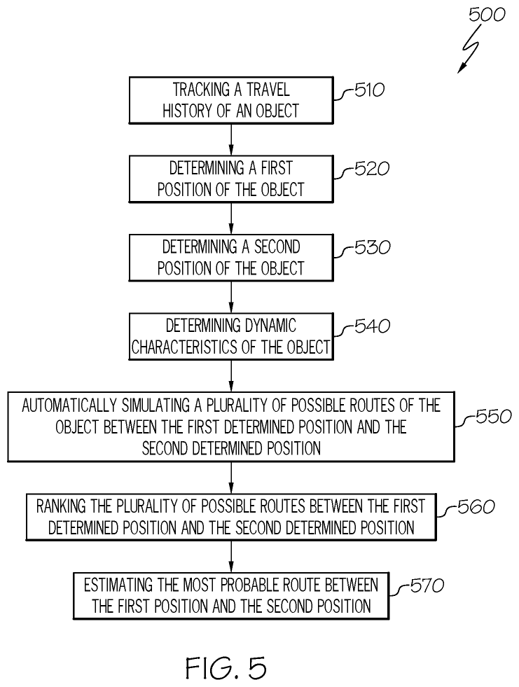

Referring now to FIG. 5, an illustration of a method 500 is illustrated consistent with a disclosed embodiment. The method 500 is directed at estimating a route traveled by the object 102 between known positions of the object 102 that may be performed by the system 100. At step 510, the method 500 includes tracking a travel history of the object 102. That is, the system may track and store past routes taken by the object 102 in the same area as the position of the object 102.

At step 520, the method 500 includes determining a first position 152 of the object 102 at a first time. That is, the position determining device 120 may determine a position of the object 102 at a first time.

At step 530, the method 500 includes determining a second position 154 of the object 102 at a second time, subsequent point to the first time. That is, the position determining device 120 may determine a position of the object 102 at a second time, subsequent to the first time.

At step 540, the method 500 includes determining a dynamic characteristic of the object 102. That is, the dynamic sensor 130 may determine a velocity and/or acceleration of the object 102.

At step 550, the method 500 includes automatically simulating a plurality of possible routes of the object 102 between the first determined position at the first time and the second determined position at the second time. That is, the system 100 may simulate multiple possible routes between the first determined position and the second determined position. In embodiments, the system 100 may reference map data 142 stored on the map device 140 to simulate multiple possible routes between the first determined position at the first time and the second determined position at the second time.

At step 560, the method 500 includes ranking the plurality of possible routes between the first determined position and the second determined position. That is, the system 100 may rank the plurality of possible routes based on the travel history of the object 102, the dynamic characteristics of the object 102, or other possible criteria.

At step 570, the method 500 includes estimating the most probable route between the first determined position and the second determined position. That is, the system 100 may estimate that the highest ranked route is the most probable route taken by the object 102 between the first determined position and the second determined position. In embodiments, the system 100 may perform the estimation while the object 102 is in motion. In other embodiments, the system 100 may perform the estimation after the object 102 has become motionless.

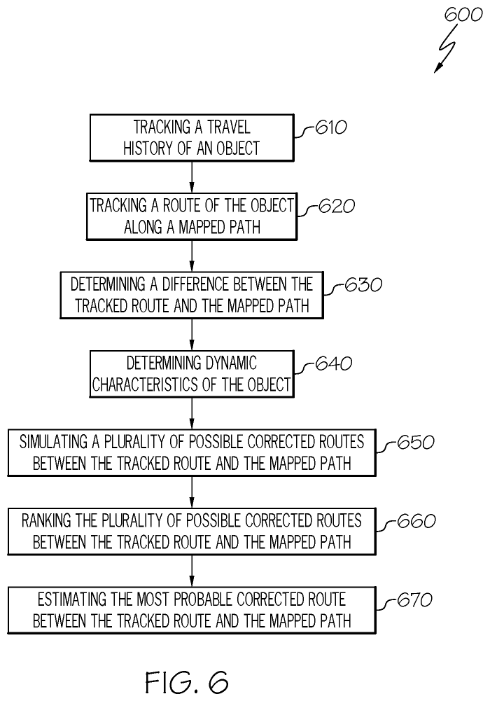

Referring now to FIG. 6, an illustration of a method 600 is illustrated consistent with a disclosed embodiment that may be performed by the system 100. The method 600 is directed at estimating a corrected route of the object 102. At step 610, the method 600 includes tracking a travel history of the object 102. That is, the system 100 may track and store past routes taken by the object 102 in the same area as the position of the object 102.

At step 620, the method 600 includes tracking a route of the object 102 along a mapped path. That is, the position determining device 120 may track the object 102 along the mapped path to determine the route taken by the object 102 along the mapped path.

At step 630, the method 600 includes determining a difference between the tracked route and the mapped path. That is, the system 100 may recognize that the tracked route of the object 102 is not along the mapped path (such as a tracked route in a field between paths of the mapped path).

At step 640, the method 600 includes determining dynamic characteristics of the object 102. That is, the dynamic sensor 130 may determine a velocity and/or acceleration of the object 102.

At step 650, the method 600 includes simulating a plurality of possible corrected routes between the tracked route and the mapped path. That is, the system may simulate multiple possible routes from the point in which the tracked route veered away from the mapped path.

At step 660, the method 600 includes ranking the plurality of possible corrected routes between the tracked route and the mapped path 146. That is, the system 100 may rank the plurality of possible routes based on the travel history of the object 102, the dynamic characteristics of the object 102, or other possible criteria.

At step 670, the method 600 includes estimating the most probable corrected route between the tracked route and the mapped path. That is, the system 100 may estimate that the highest ranked corrected route is the most probable corrected route taken of the object 102. In embodiments, the system 100 may perform the estimation while the object 102 is in motion. In other embodiments, the system 100 may perform the estimation after the object 102 has become motionless.

Accordingly embodiments of the present disclosure provide a method for estimating a route of an object which may more effectively estimate the route taken by an object. Particularly, the system may use object travel history, object dynamic characteristics, or various other criteria to rank a plurality of different simulated routes. In embodiments, the system may operate in real time to determine a route being taken by the object. In other embodiments, the system may operate after a journey has been completed to estimate the route taken by the object. The system may simulate a plurality of possible routes for a longer duration than a conventional route estimation method.

It may be noted that one or more of the following claims utilize the terms “where,” “wherein,” or “in which” as transitional phrases. For the purposes of defining the present technology, it may be noted that these terms are introduced in the claims as an open-ended transitional phrase that are used to introduce a recitation of a series of characteristics of the structure and should be interpreted in like manner as the more commonly used open-ended preamble term “comprising.”

It should be understood that any two quantitative values assigned to a property may constitute a range of that property, and all combinations of ranges formed from all stated quantitative values of a given property are contemplated in this disclosure.

Having described the subject matter of the present disclosure in detail and by reference to specific embodiments, it may be noted that the various details described in this disclosure should not be taken to imply that these details relate to elements that are essential components of the various embodiments described in this disclosure, even in casings where a particular element may be illustrated in each of the drawings that accompany the present description. Rather, the claims appended hereto should be taken as the sole representation of the breadth of the present disclosure and the corresponding scope of the various embodiments described in this disclosure. Further, it will be apparent that modifications and variations are possible without departing from the scope of the appended claims.

What is claimed is:

1. A method comprising:
determining a first position of an object at a first time;
determining a second position of the object at a second time subsequent to the first time;
automatically simulating a plurality of possible routes between the first position and the second position;
ranking the plurality of possible routes between the first position and the second position; and
estimating a most probable route from among the plurality of possible routes between the first position and the second position.

2. The method of claim 1, wherein the object comprises a vehicle.

3. The method of claim 1, wherein the step of ranking the plurality of possible routes between the first position and the second position further comprises:
determining an object velocity at the first positon of the object; and
ranking the plurality of possible routes between the first position and the second position based at least partially on the object velocity at the first position of the object.

4. The method of claim 1, wherein the step of ranking the plurality of possible routes between the first position and the second position further comprises:
determining an object acceleration at the first positon of the object; and
ranking the plurality of possible routes between the first position and the second position based at least partially on the object acceleration at the first position of the object.

5. The method of claim 1, wherein the step of estimating the most probable object route from among the plurality of possible object routes is based at least partially on an object travel history.

6. The method of claim 1, further comprising displaying the most probable route on a display.

7. The method of claim 1, wherein the position of the object is not known between the first position of the object and the second position of the object.

8. The method of claim 1, wherein the step of determining the first position of the object further comprises determining a first position of the object with GPS, and determining the second position of the object further comprises determining a second position of the object with GPS.

9. The method of claim 1, wherein the estimated routes are along a mapped road network.

10. The method of claim 9, wherein the estimated routes are aligned with the mapped road network.

11. The method of claim 1, wherein the step of estimating the most probable route from among the plurality of possible routes between the first position and the second position further comprises estimating while the object is in motion.

12. The method of claim 1, wherein the step of estimating the most probable route from among the plurality of possible routes between the first position and the second position further comprises estimating after the object has become motionless.

13. A method comprising:
tracking a route of an object along a mapped path to determine a tracked route of the object;
determining a difference between the mapped path and the tracked route of the object;
simulating a plurality of possible corrected routes from the tracked route to the mapped path;
ranking the plurality of possible corrected routes between the tracked route and the mapped path; and
estimating a most probable corrected route from among the plurality of possible corrected routes between the tracked route and the mapped path.

14. The method of claim 13, wherein the object comprises a vehicle.

15. The method of claim 13, wherein the step of ranking the plurality of possible routes between the tracked route and the mapped path further comprises:
determining an object velocity along the tracked route of the object; and
ranking the plurality of possible routes between the tracked route and the mapped path based at least partially on the object velocity along the route.

16. The method of claim 13, wherein the step of estimating the most probable route from among the plurality of possible routes between the tracked route and the mapped path is based at least partially on an object travel history.

17. The method of claim 13, further comprising:
determining an object acceleration along the route of the object; and
ranking the plurality of corrected routes between the tracked route and the mapped path based at least partially on an acceleration of the object along the route of the object.

18. The method of claim 13, wherein the step of tracking the route of the object further comprises tracking the route of the object with GPS.

19. The method of claim 13, wherein the step of estimating the most probable route from among the plurality of possible routes between the tracked route and the mapped path is performed while the object is in motion.

20. The method of claim 13, further comprising displaying the detected and/or corrected route on a display.
